(19) United States
(12) Patent Application Publication
(10) Pub. No.: US 2025/0155360 A1
(43) Pub. Date: May 15, 2025

(54) BROADBAND PHOTOACOUSTIC AMPLIFICATION METHOD FOR SENSITIVE MULTI-SPECIES DETECTION

(71) Applicant: The Chinese University of Hong Kong, Hong Kong (CN)

(72) Inventors: Wei REN, Hong Kong (CN); Zhen WANG, Hong Kong (CN); Qinxue NIE, Hong Kong (CN)

(21) Appl. No.: 18/947,095

(22) Filed: Nov. 14, 2024

Related U.S. Application Data
(60) Provisional application No. 63/598,661, filed on Nov. 14, 2023.

(51) Int. Cl. G01N 21/17

(52) U.S. Cl. CPC G01N 21/1702; G01N 2021/1704

(57) ABSTRACT

A system and methods for amplified broadband photoacoustic detection of multi-species with high sensitivity are provided. The system is configured to simultaneously amplify the intensity of acoustic waves and optical waves with a series of frequencies and includes dual frequency combs as the optical pump covering broadband spectral features of molecules. A high-finesse optical resonator is configured to amplify the power of the frequency combs and an acoustic resonator is configured with multiple microphones, providing broadband and flat-top frequency response to amplify the light-absorption-induced acoustic waves. The signals of the microphones are summed by a low-noise circuit and processed by a Fast Fourier Transform method to obtain multiple frequency components, resulting in multi-species and sensitive photoacoustic detection in a compact gas chamber.

### CROSS-REFERENCE TO RELATED APPLICATION

This application claims the benefit of U.S. Provisional Application Ser. No. 63/598,661, filed Nov. 14, 2023, which is hereby incorporated by reference in its entirety including any tables, figures, or drawings.

### FIELD OF THE INVENTION

The invention generally relates to combining broadband acoustic and optical resonators into photoacoustic spectroscopy for high-sensitivity, quantitative, and fast measurements of concentrations of multi-species. Especially, an apparatus is disclosed for simultaneously amplifying the intensity of acoustic waves and optical waves using dual frequency combs as the optical pump.

### BACKGROUND OF THE INVENTION

Photoacoustic spectroscopy (PAS) is one of the most widely used spectroscopic techniques in gas sensing, attributed to its high-selectivity and high-sensitivity. Instead of directly detecting laser intensity attenuation due to gas absorption using a photodetector-based direct absorption spectroscopy, PAS detects the amplitude of acoustic waves in the gas medium induced by the non-radiative collisional relaxation of the excited molecules after absorbing photons. Representative implementations of acoustic transducers used in PAS include microphone, quartz tuning fork, and cantilever. To enhance the PAS sensitivity, acoustic resonators are deployed to amplify the weak acoustic waves generated in the gas medium.

Conventionally, the acoustic resonator is designed with a high Q-factor, yielding maximal acoustic enhancement and narrowest bandwidth at its single fundamental resonance frequency. As a result, the acoustic resonator is generally configured with a single frequency laser to detect only one or two gas species. Since the amplitude of the PAS signal is proportional to the laser power, U.S. Pat. No. 7,263,871 discloses a method in which a Fabry-Pérot (F-P) optical resonator is integrated to amplify the power of the single frequency laser [1].

For PAS-based multi-species detection, frequency comb has been proven an ideal pump source for generating a series of acoustic waves [2]. However, the broadband characteristics of frequency combs are compromised by the narrow bandwidth of the acoustic transducer/resonator which encompasses a range of several to a few tens of Hz [3]. Consequently, the acoustic waves out of the resonant range are significantly attenuated.

In light of these constraints, EP. Pat. No. 3 865 851 disclosed a photoacoustic dual-comb spectrometer and that the difference in repetition frequency needed to be adapted to the narrow bandwidth of the acoustic detector [4]. Besides the narrow resonant bandwidth, the weak power of the frequency comb teeth is another limiting factor for improving the PAS sensitivity [5].

Hence, there emerges a compelling interest for combining the broadband optical and the acoustic resonators for overcoming the limitations of the multi-species and high-sensitivity PAS detection. The F-P optical resonator accumulates light at its resonances, corresponding to a series of optical frequencies separated by an amount of free spectral range (FSR). An optical resonator serves as a good optical amplifier for the frequency comb when its repetition frequency is equal to an integer multiple of the optical resonator's FSR. U.S. Pat. No. 7,538,881 describes a methodology for coupling single frequency comb with the optical resonator [6]. However, for photoacoustic detection based on dual-comb spectroscopy (DCS), two frequency combs with a slight difference in the repetition frequency have to be simultaneously coupled into the optical resonator. Nevertheless, the locking technique of dual-comb and the optical resonator was lacking.

As a response to this challenge, combination of broadband acoustic resonator and the dual-comb with power enhanced by optical resonator provides a realistic solution for sensitive multi-species detection for the broadband photoacoustic amplification methodology.

Since its first demonstrations two decades ago [1-4], DCS has undergone a substantial evolution, subsequently emerging as a powerful tool across diverse domains such as spectroscopy and microscopy [5-9], precision metrology [10,11], spectral lidar [12,13], environmental monitoring [14,15], and advanced hyperspectral holography and imaging [16,17]. Notably, DCS plays a pivotal role in modern high-precision and broadband molecular spectroscopy, rapidly performing Fourier transform spectroscopy without using any moving parts.

In this configuration, one frequency comb passes through a gas sample to be analyzed and beats on a photodetector with a second phase-locked comb with a slightly different repetition rate. The multiheterodyne beats between pairs of comb lines generate an interferometric signal, which is accessible by radio-frequency (RF) electronics and can be Fourier-transformed to reveal the sample's spectrum. It is noteworthy that DCS can fully capitalize on the frequency resolution and accuracy, broad bandwidth, and high repetition rate of different types of comb sources for high-speed, ultrahigh-resolution and broadband spectroscopy [6,7,18-22].

Conventional DCS is implemented by precisely measuring the transmitted comb light intensity using a fast photodetector. Nevertheless, accurate extraction of the absorption spectrum from the large background signal represents a nontrivial undertaking, especially, for weak absorbance. In contrast to direct absorption measurements, DCS can alternatively take advantage of various spectroscopic techniques such as photoacoustic and photothermal detection [23-25]. These indirect methodologies for absorption measurements enable the background-free detection of molecular spectra, where exclusively the comb lines absorbed by the gas medium can generate the photoacoustic/thermal multi-heterodyne beatnotes.

For instance, PAS normally uses a microphone to detect acoustic waves, which are generated by the non-radiative collisional relaxation of the excited molecules after absorbing the modulated light. Sadiek et al. reported the first PAS using a frequency comb and implemented a Fourier transform spectrometer (FTS) to modulate the intensity of the frequency comb [26]. To eliminate the requirement for mechanical parts in FTS, photoacoustic DCS has recently been developed for measuring gaseous acetylene (C₂H₂) [23] and polymer films [24]. However, it is imperative to note that in these proof-of-concept experiments, the detection sensitivity remains a concern. Specifically, a minimum detection limit (MDL) of 10 ppm is achieved for C₂H₂ detection at a recording time of 1000 s [23].

By replacing the microphone with a quartz tuning fork (QTF) having a high Q-factor, the QTF-based photoacoustic DCS was developed, leading to an improvement of the MDL to 8.3 ppb C₂H₂ [27]. Nevertheless, the generated RF comb lines lie within the extremely narrow resonance bandwidth (several Hz) of the QTF, significantly limiting the detection bandwidth. Therefore, the capability of simultaneously achieving high sensitivity and broad bandwidth for photoacoustic DCS has been hindered by lacking high-power comb light for exciting the photoacoustic effect and broadband acoustic resonators for effectively amplifying all the generated acoustic waves.

### BRIEF SUMMARY OF THE INVENTION

Embodiments of the subject invention pertain to a system and methods combining broadband acoustic and optical resonators into photoacoustic spectroscopy for high-sensitivity, quantitative, and fast measurements of concentrations of multiple species.

According to an embodiment of the subject invention, a system for amplified broadband photoacoustic detection of multi-species with high-sensitivity comprises a light source for generating a light beam having a wavelength covering absorption lines of target gaseous analytes; a controller for controlling wavelength and intensity of the light beam; an acoustic resonator generating broadband frequency response configured to amplify generated acoustic waves over a wide frequency range; an acoustic transducer configured to detect the generated acoustic waves; an electrical sum circuit for adding electrical signals from the acoustic transducer; an optical resonator configured to enhance power of the light beam; a gas cell for providing an absolute frequency standard; a first locking loop configured to stabilize absolute wavelength of a light source by referencing to a molecular absorption line; a second locking loop configured to stabilize longitudinal modes of the optical resonator by referencing to the stabilized light source; a third locking loop configured to maintain stable power enhancement of the optical resonator; a first photodetector configured to detect transmitted light from the gas cell for locking the light source to the absorption line of the gas filled in the gas cell; a second photodetector configured to detect reflected light from the optical resonator for locking the light source to a longitudinal mode of the optical resonator; an optical coupler configured to combine two light sources; a lens configured to match transverse mode of the light beam with transverse mode of the optical resonator; a combination of polarized beamsplitter (PBS) and quarter-wave plate (QWP) configured to separate the light reflected by a front mirror of the optical resonator from incident light; an electrical splitter configured to split the electrical signal for generating different error signals; three Pound-Drever-Hall (PDH) modules configured to extract error signals and generate feedback signals for the three locking loops; and a piezoelectric (PZT) actuator attached to the rear mirror of the optical resonator to finely adjust the length of the optical resonator. The light source controlled by the controller is generally wavelength-modulated or intensity-modulated to generate acoustic waves after interacting with a gaseous analyte. The acoustic resonator generating broadband frequency response comprises a longitudinal resonator sandwiched by a pair of buffers and a pair of caps with holes for obtaining broadened frequency response. The acoustic resonator configured with several acoustic transducers to detect acoustic waves and the acoustic transducers are microphones in this demonstration. The electrical sum circuit is configured to improve the intensity of the acoustic signal and flatten the frequency response over a broad frequency range by summing electrical signals generated by the acoustic transducer. Moreover, the light source is a single-wavelength light source or a light source with a broadband spectrum, comprising optical frequency combs. The power of the light source for generating acoustic waves is enhanced by an optical resonator. The optical resonator is a Fabry-Pérot optical cavity, bow-tie optical cavity, or another type of optical cavity for enhancing the optical power. Further, the absolute wavelength of the light source is stabilized by referencing to a molecular absorption line via a frequency locking method based on PDH locking or another locking method including first harmonic locking. The longitudinal mode of the optical resonator is stabilized by referencing to the stabilized light source via PDH locking. The stable enhancement of the light power in the optical resonator for photoacoustic detection is achieved by maintaining resonance between the light source and the optical resonator by PDH locking. The coupler is configured to allow two light sources to enter the optical resonator together to realize the stable power enhancement in the optical resonator. The lens is configured to adjust the transverse mode of the light beam to match with the transverse mode supported by the optical resonator, maximizing coupling efficiency and achieving the maximum power in the optical resonator. In addition, the combination of PBS and QWP is configured to retrieve the reflected light from the optical resonator as the reflected light is overlapped with the incident light. The electrical splitter is configured to split the electrical signal from the photodetector for different locking loops. The PDH modules integrate modulation and demodulation, in which modulation signals are sent to the controller or additional modulators to generate sidebands for implementing PDH locking. The PZT actuator is attached to the rear mirror of the optical resonator to stabilize the longitudinal mode of the optical resonator following the feedback signal from the PDH module.

In another embodiment of the subject invention, a method of cavity-enhanced photoacoustic dual-comb spectroscopy (DCS) for ultrasensitive, broadband, and high-resolution spectroscopic detection is provided. The method comprises generating seed laser beams; dividing the seed laser beams into two branches, each being connected in parallel to an acousto-optic modulator (AOM) shifting optical frequency by a different degree; generating two trains of frequency combs by intensity modulating the two branches by electro-optic modulators (EOMs); passing the two trains of frequency combs through Erbium-doped fiber amplifiers (EDFAs); counter-launching the two trains of frequency combs into a single dispersion compensated fiber; and mixing the two combs to form a dual-comb and splitting the dual-comb into two beams by a fiber coupler for photoacoustic detection and power normalization, respectively. Moreover, the two trains of frequency combs generated share a same carrier frequency. A first train of the frequency combs with a repetition rate f_{r,1}, locking the seed laser (f_{c}) to a Fabry-Pérot cavity enclosed in a gas cell, enabling overlap between a central comb line and one cavity mode by a PDH method. A second train of the frequency combs is coupled to the cavity by tuning f_{r,1} such that it perfectly matches a free spectral range of the optical cavity.

### BRIEF DESCRIPTION OF THE DRAWINGS

FIG. 1A is schematic diagram of experiment setup of the acoustic resonator of the broadband photoacoustic amplification system and methods and FIG. 1B is a graph showing the broadband frequency response generated by the acoustic resonator, according to an embodiment of the subject invention.

FIG. 2 is a schematic diagram of the broadband photoacoustic amplification system and methods based on dual frequency combs, according to an embodiment of the subject invention.

FIG. 3 is a schematic diagram showing the coupling of dual frequency combs to an optical resonator, according to an embodiment of the subject invention.

FIG. 4A is a schematic diagram showing working principle of cavity-enhanced photoacoustic dual-comb spectroscopy (DCS), wherein the dual-frequency combs are coupled to an optical cavity for power enhancement when all the comb lines exhibit a perfect match with the cavity modes; after absorption by the target gas molecules, the multi-heterodyne of the intracavity dual-combs generates multiple acoustic waves with the frequencies determined by the difference of repetition rates (Δfᵣ) and central frequency shifts (Δf_{shift}); and wherein a flute-type acoustic resonator with a broadband frequency response is configured to amplify the generated photoacoustic waves, according to an embodiment of the subject invention.

FIG. 4B is a schematic diagram of the experiment setup of cavity-enhanced photoacoustic dual-comb spectroscopy, wherein the electro-optic dual-comb source employs a continuous wave (CW) seed laser at an optical frequency f_{c}, which is divided into two branches and connected in parallel with pairs of acousto-optic modulators (AOMs) to control the central frequency shifts (f_{shift,1} and f_{shift,2}) and electro-optic modulators (EOMs) to control the repetition rates (f_{r,1} and f_{r,2}), wherein the generated optical pulses are then amplified by two Erbium-doped fiber amplifiers (EDFAs) and counter-launched into a nonlinear dispersion compensated fiber (DCF), wherein a photodetector (PD) is configured with the dual-comb source to monitor the multiheterodyne reference spectrum, wherein three Pound-Drever-Hall (PDH) locking loops are configured to match the comb lines with the cavity modes: the AOM-shifted seed laser is phase-modulated by EOM1 (19 MHz) to stabilize the carrier frequency (f_{c}) with respect to the Fabry-Pérot cavity; a narrow-linewidth laser (NLL) is phase-modulated by EOM2 (13 MHz) to lock with the optical cavity and by EOM3 (99 MHz) to lock with an absorption line of C₂H₂ at 10 Torr, respectively, wherein the two CW lasers are arranged in orthogonal polarization with the dual-comb light to inhibit optical crosstalk, and combined via a polarization beam splitter (PBS) before entering the optical cavity, and wherein the broadband acoustic resonator is situated inside the optical cavity for acoustic wave amplification and two microphones (MICs) are utilized to detect the acoustic waves, according to an embodiment of the subject invention.

FIG. 4C is a graph showing characterized frequency response of the broadband acoustic resonator of FIG. 4B, according to an embodiment of the subject invention.

FIG. 5A is a graph showing representative cavity-enhanced photoacoustic DCS signals of 10 ppm C₂H₂ (top panel) and the corresponding incident intensities of the dual-comb (bottom panel), according to an embodiment of the subject invention.

FIG. 5B is a graph showing representative single-pass photoacoustic DCS signals of 5000 ppm C₂H₂ (top panel) and the corresponding incident intensities of the dual-comb (bottom panel), wherein the average measurement time is 60 seconds, wherein the acoustic frequency scale (kHz) is converted to the optical domain based on the frequency compression factor fᵣ/Δfᵣ and the carrier frequency f_{c}, and wherein a strong absorption line of C₂H₂ at 195.895 THz and a weak line at 195.818 THz are observed in this frequency range, according to an embodiment of the subject invention.

FIG. 6 shows broadband cavity-enhanced photoacoustic DCS measurements of 10 ppm C₂H₂, 50 ppm NH₃ and 1% CO over the telecommunications C-band at the atmospheric pressure (760 Torr), wherein the spectral simulation based on the HITRAN database is also plotted for comparison, and wherein the insets show weak signatures of C₂H₂ and NH₃ resolved by the cavity-enhanced photoacoustic dual-comb system, according to an embodiment of the subject invention.

FIG. 7A is a graph showing variations of the photoacoustic amplitude with C₂H₂ concentration, demonstrating a good linear response with an R² value of 0.9976 and a better linearity with a higher R² value of 0.9984 after normalization, wherein the vertical error bars (1−σ standard deviation) are calculated from the raw data, taken with a time interval of 60 seconds, according to an embodiment of the subject invention.

FIG. 7B is a graph showing Allan-Werle deviation analysis of C₂H₂ detection, wherein the measurements are conducted by recording the response of pure N₂ for one hour with all locking loops turned on, according to an embodiment of the subject invention.

FIG. 8A is a graph showing characterization of the acoustic resonators with different configurations, especially the frequency responses of the acoustic resonators with different inner diameters (IDs), according to an embodiment of the subject invention.

FIG. 8B is a graph showing frequency responses of the acoustic resonators with end caps, wherein the inner diameter of the central resonator is fixed at 2 mm, while the diameter (D) of the through holes in the end caps is varied between 2 mm and 5 mm, according to an embodiment of the subject invention.

FIG. 8C is a graph showing frequency responses of the flute-type acoustic resonator with different configurations of microphones, according to an embodiment of the subject invention.

### DETAILED DISCLOSURE OF THE INVENTION

Embodiments of the subject invention pertain to a system and methods including an acoustic resonator capable of broadband acoustic amplification combined with an optical resonator to realize high-sensitivity broadband photoacoustic detection of multi-species.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not prelude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

### Embodiment One: Broadband Photoacoustic Amplification System and Methods

Broadband acoustic and optical resonators are combined for sensitive, quantitative and fast detection of multi-species. In particular, the dual frequency combs (DFCs) are integrated with a broadband acoustic resonator to take advantages of the dual-comb spectroscopy and the PAS for performing high-sensitivity and broadband detection.

In one embodiment, DFCs are employed as the pump light covering the broadband spectral features of multiple types of molecules. An optical resonator with a high finesse (>4000) is configured to amplify the dual-comb power. The multi-heterodyne beating between the two combs can generate a series of acoustic waves with different frequencies, when they are absorbed by the gas molecules. An acoustic resonator with broadband and flat-top frequency response is configured to amplify the generated acoustic waves. Moreover, multiple microphones are configured to detect the generated acoustic waves and a low-noise circuit is configured to sum the electrical signals generated by these microphones. Then the photoacoustic spectrum can be obtained by performing FFT analysis on the circuit output.

As a result, multi-species and sensitive photoacoustic detection is achieved in a compact gas chamber, showing potential in chemical and biological sensing, environmental trace gas detection, and isotopic detection.

Further, the PAS measures the acoustic waves generated in the relaxation process of the excited gas molecules after absorbing the modulated laser radiation. The intensity of the generated acoustic wave is proportional to the absorption coefficient of the target gas and the incident laser power. Conventionally, to amplify the generated weak acoustic waves for high-sensitivity PAS, an acoustic resonator is designed to form an acoustic standing wave at its resonance frequency, and the acoustic transducer is usually placed at the antinode to detect the amplified acoustic wave. However, this method has limited detection bandwidth.

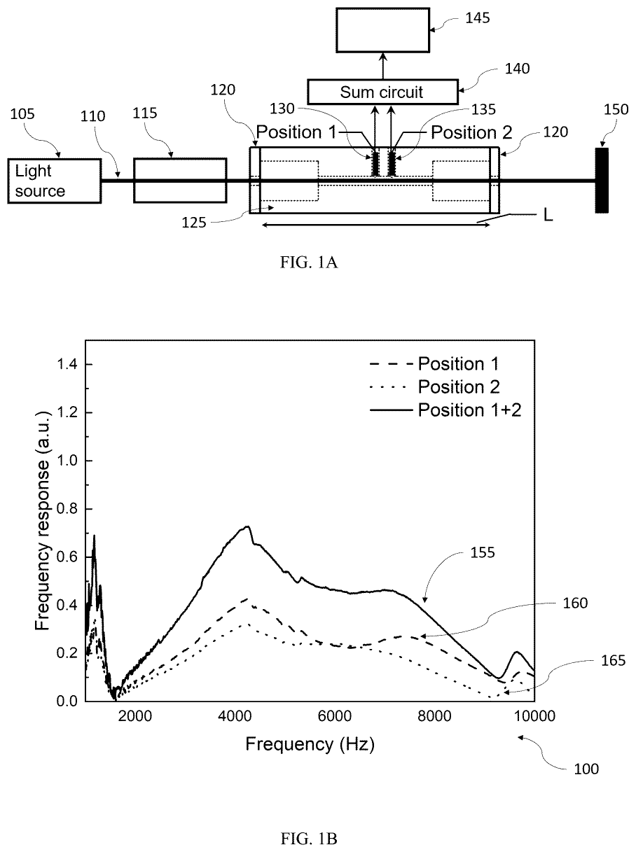

As shown in FIGS. 1A and 1B, the broadband frequency responses of the acoustic resonator are obtained by the experiment setup of the PAS. In FIG. 1A, the light source 105 outputs a light beam 110 through the gas mixture filled in the acoustic resonator 125. To generate photoacoustic signal, an optical intensity or frequency modulator 115 is utilized to modulate the light intensity or the optical frequency of the light beam 110. The acoustic resonator 125 includes a body part and two caps 120. The body part is configured to form an acoustic standing wave and the caps with central holes are configured to adjust the sound boundary condition to obtain a wider frequency bandwidth. Two microphones 130 and 135 are installed at different locations on the body part of the acoustic resonator 125. The microphone 130 is located at the center of the body part, that is, the acoustic antinode, to detect the antinode of the acoustic standing wave formed in the acoustic resonator. The other microphone 135 is located next to microphone 130 to detect acoustic signal near the antinode, where the acoustic signal shows different frequency response with an intensity slightly smaller than that of the antinode. A gas mixture containing, for example, 5000 parts-per-million (ppm) C₂H₂ balanced by N₂ is filled in the body part to generate photoacoustic signals. The frequency responses detected by the microphones 130 and 135 are shown by the curve 160 and curve 165 of FIG. 1B, respectively. By adding the electrical signals generated by the microphones 130 and 135 through a sum circuit 140, a new frequency response curve 155 is obtained with larger amplitude and a flatter top. A beam dump 150 can be additionally installed to absorb the transmitted light beam.

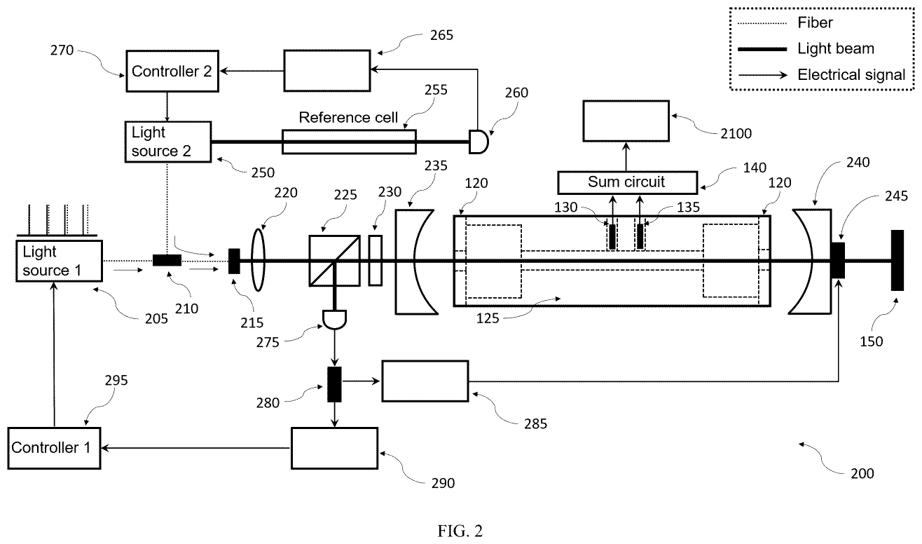

Since the photoacoustic signal is proportional to the light power, the acoustic resonator can be integrated with a Fabry-Pérot (F-P) optical resonator that enhances light power to improve sensitivity of photoacoustic detection. As shown in FIG. 2, the F-P optical resonator comprises a front mirror 235 and a rear mirror 240. Both mirrors have high-reflectivity coatings on the concave side and high transmissivity on the plane side. A piezoelectric (PZT) actuator 245 is attached on the rear mirror to adjust the length between the two mirrors. A module of mode-matching lens 220 is adopted to shape the transverse mode of the light beam to match the transverse mode of the optical resonator. Further, a feedback locking system is employed to match the optical frequency of the light source with the longitudinal mode of the optical resonator. The feedback locking system includes three feedback loops built to work synchronously. The first feedback loop includes a single-wavelength light source 250, a reference gas cell 255, a photodetector 260, a Pound-Drever-Hall (PDH) locking module 265, and a laser controller 270. This loop is designed to lock the wavelength of the light source 250 to an absorption line of the gas sealed in the gas cell 255, which is used as an absolute frequency standard. The second feedback loop includes the light source 250, an optical coupler 210, a fiber collimator 215, a polarized beamsplitter (PBS) 225, a quarter-wave plate (QWP) 230, a PZT 245, a photodetector 275, an electrical splitter 280 and a PDH module 285. This loop is designed to stabilize the length of the optical resonator by referencing to the wavelength of light source 250. These two locking loops work collaboratively to stabilize the length of the optical resonator by referencing to the molecular absorption line. The third locking loop is designed to lock the optical frequency of the light source 205 to the stabilized optical resonator. This loop includes the light source 205, an optical coupler 210, a fiber collimator 215, a PBS 225, a QWP 230, a photodetector 275, an electrical splitter 280, a PDH module 290, and a laser controller 295. Since the second and the third locking loops are almost overlapped, the laser beam from the light sources 205 and 250 are modulated at different frequencies. The mismatch between the optical resonator and the light source 205 is carried in the frequency component which is demodulated by the PDH module 290; and the mismatch between the optical resonator and the light source 250 is carried in the other frequency component which is demodulated by the PDH module 285. The output of the PDH module 285 is used to finely adjust the length of the optical resonator to maintain the locking between the optical resonator and the light source 250 via the PZT 245. The output of the PDH module 290 is sent to the controller 295 to rapidly adjust the wavelength of the light source 205 to maintain its resonance with the optical resonator. With these three locking loops, the pump light source (either single-wavelength or optical frequency comb) can be enhanced by the optical resonator. In particular, when the dual frequency combs (DFCs) are configured as the light source, the optical modulator 115 is not needed since the beatnotes of each pair of comb teeth provide the intensity modulation. The output signals of the electrical sum circuit 140 are then analyzed by a Fast Fourier Transform (FFT) method integrated in the module 2100.

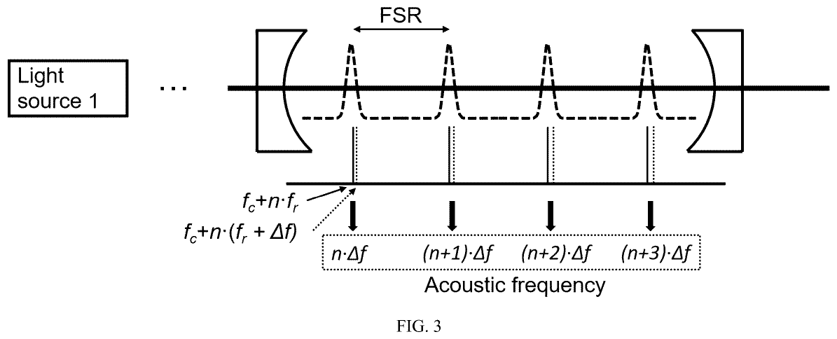

Referring to FIG. 3, a method of generating multiple acoustic waves by the multi-heterodyne of DFCs, which are enhanced by the optical resonator simultaneously, is provided. The DFCs include two optical frequency combs with different repetition rates of fᵣ and fᵣ+Δf, in which the Δf is the repetition rate difference. The beat-note signal components between the two optical frequency combs occur at the frequencies n·Δf, (n+1)·Δf, (n+2)·Δf, . . . , where n is an integer number. The generated acoustic waves have the same frequencies as the beat-note signal. The intensity of all the generated acoustic waves can be enhanced by coupling the DFCs to an optical resonator. Benefiting from the MHz-level mode width of the optical resonator, the DFCs with a frequency difference at kHz-level can be coupled into the optical resonator at the same time.

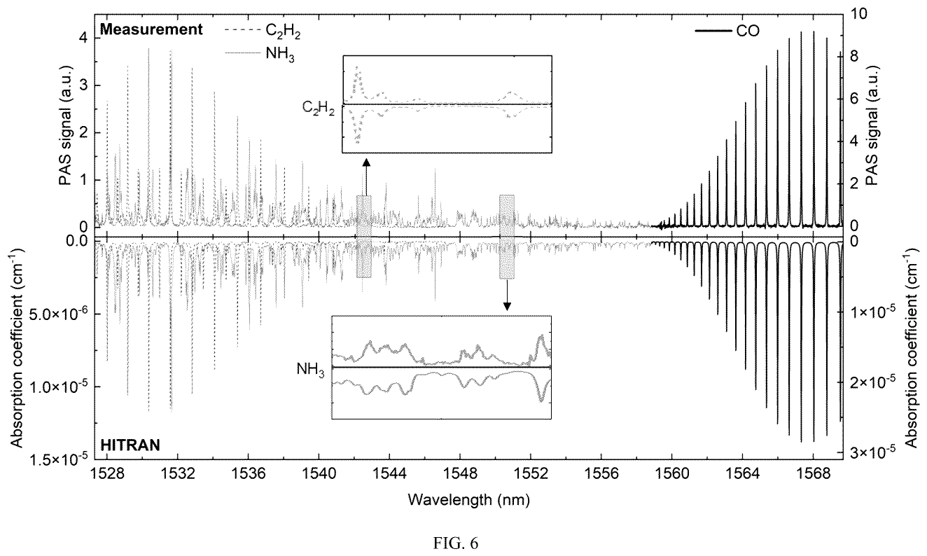

FIG. 6 shows the spectral measurement of multi-species including C₂H₂ (10 ppm), NH₃ (50 ppm), and CO (1%) in the telecommunications C-band (1527.3-1569.7 nm) using the DFCs as the light source 205 in the experiment setup of FIG. 2. At the averaging time of 1 second, the system achieves a minimum detection limit (MDL) of 18 parts per billion (ppb) for C₂H₂, 42 ppb for NH₃, and 324 ppm for CO, respectively. The results verify that the method is capable of achieving broadband multi-species detection with high sensitivity.

With the enhanced light power in the optical resonator and the amplified acoustic wave in the broadband acoustic resonator, the acoustic resonators can simultaneously measure photoacoustic spectra of multi-species over a wide frequency range, performing molecular detection with high sensitivity without the limitation of frequency bandwidth of modulation.

### Embodiment Two: Cavity-Enhanced Photoacoustic DCS

Cavity-enhanced photoacoustic DCS is provided for ultrasensitive, broadband, and high-resolution spectroscopic detection. First, a flute-type acoustic resonator is employed for sensitive photoacoustic detection with a 3-dB bandwidth of a frequency higher than 5 kHz in the audio frequency range of, for example, 2.9-8.0 kHz. Second, two trains of frequency combs are simultaneously injected into a high-finesse optical cavity, enabling the intracavity power build-up by several orders of magnitude and achieving broad detection bandwidth provided by the acoustic resonator and the remarkable comb power enhancement afforded by the optical cavity. As a result, high-resolution cavity-enhanced photoacoustic DCS is achieved, capable of detecting multiple gas-phase species including C₂H₂, NH₃ and CO in the entire telecommunications C-band with an ultra-high sensitivity.

### Working Principle

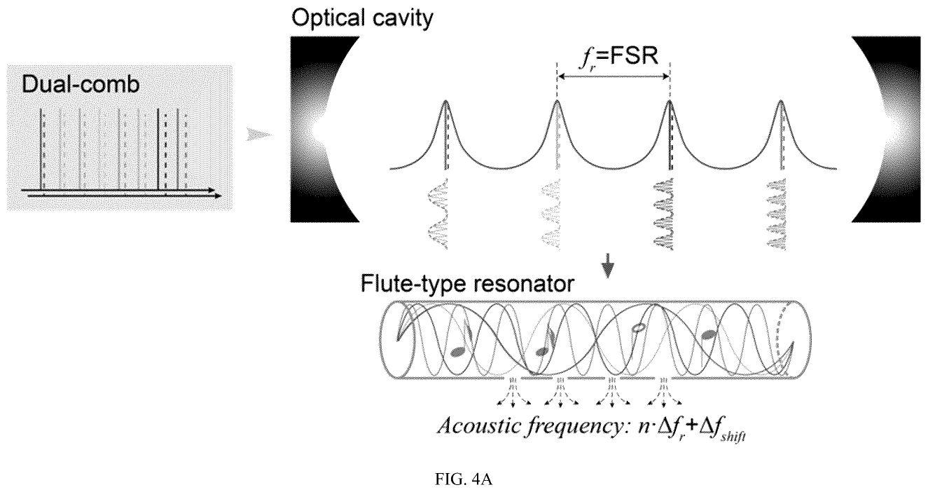

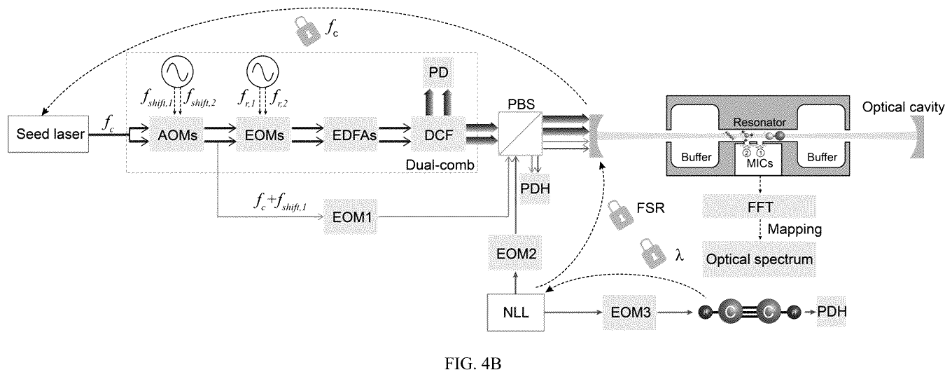

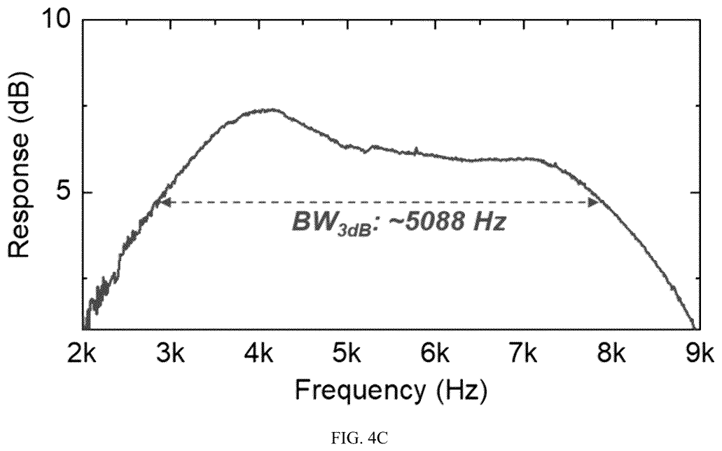

The working principle of the cavity-enhanced photoacoustic DCS is illustrated in FIG. 4A. Different from the dual-comb absorption measurement in an optical cavity [28-31], the cavity-enhanced photoacoustic DCS requires the two combs to be simultaneously coupled into a cavity to enable the generation of intracavity dual-comb multiheterodyne beatnotes. Provided both combs effectively enter the cavity for power enhancement, the multi-heterodyne beating between each comb-line pair brings forth amplitude modulation of the cavity-enhanced comb line. Absorption by the target molecules leads to the excitation of hundreds or thousands of acoustic waves with evenly spaced frequencies determined by the repetition rate difference (Δfᵣ) and central frequency shifts (Δf_{shift}) between the two phase-coherent combs [23,25]. It is desirable to have a broadband and open-ended acoustic resonator situated inside the optical cavity, further amplifying the acoustic waves for detection with higher sensitivity.

### Experiment Setup

Referring to FIG. 4B, an electro-optic dual-comb source is used for demonstration purposes considering its flexible tuning of repetition rate (fᵣ) and optical carrier frequency (f_{c}). The two trains of frequency combs generated from the same continuous wave (CW) seed laser share the same (not constant) carrier frequency. For one train of the frequency combs with the repetition rate f_{r,1}, locking the seed laser (f_{c}) to the Fabry-Pérot cavity enclosed in a gas cell enables the overlap between the central comb line and one cavity mode, which can be conducted using the Pound-Drever-Hall (PDH) method. The other comb lines are coupled into the cavity by tuning f_{r,1} such that it perfectly matches the free spectral range (FSR, about 833 MHz) of the optical cavity. To obtain a temporally invariant FSR, a stable narrow-linewidth CW laser (1531.58 nm) shown in FIG. 4B is employed as an optical intermedium to stabilize the cavity length by locking the cavity mode to an absorption line of C₂H₂. As a result, all the comb lines with repetition rate f_{r,1} are arranged in perfect resonance with the cavity modes, whereas the counterpart of the dual-comb source with a slight difference in the repetition rate (f_{r,2}=f_{r,1}+Δfᵣ, where Δfᵣ=30 Hz) can automatically enter the cavity. A negligible difference (<0.7%) in the relative intensity attenuation for the two comb lines coupled into the same cavity mode (MATERIALS AND METHODS) is estimated. Moreover, the possible interference between the three locking loops is eliminated by an orthogonal polarization arrangement for the comb light and CW lasers and modulation frequencies are selected for the three EOMs for PDH locking purposes.

The broadband acoustic detector serves as a key element in the photoacoustic DCS. Inspired by the flute instrument, a broadband acoustic resonator is designed to amplify many acoustic waves with distinct frequencies. As shown in FIG. 4B, it includes a longitudinal acoustic resonator (for example, length: 35 mm; inner diameter: 2 mm) in the center, connected with two buffering volumes (for example, length: 17.5 mm; inner diameter: 12 mm). Two end-caps are used to cover the buffering volumes, and a central through hole (for example, diameter: 2 mm) is made in each cap for optical access. For acoustic wave detection, two microphones are installed in the central acoustic resonator and the superimposed electrical signals are added by a low-noise summing circuit. Then, the microphone output is digitized and Fourier-transformed to obtain the photoacoustic spectrum. It is noted that all the signal generators and the data-acquisition devices are synchronized to a rubidium clock to maintain long-term locking and measurement stability.

The frequency responses of the broadband acoustic resonator are characterized by measuring the photoacoustic signal of 10 ppm C₂H₂/N₂ using a 1531.58-nm CW laser at varied intensity modulation frequencies. As shown in FIG. 4C, the acoustic resonator demonstrates an excellent flat-top frequency response with a bandwidth (3 dB) of 5088 Hz in the frequency range of 2.9-8.0 kHz. This is tens of times broader than the traditional longitudinal acoustic resonator [34], and over three orders of magnitude larger than the existing QTF [27]. As discussed later, such a broadband response benefits from the merging of higher-order acoustic modes inside the acoustic resonator.

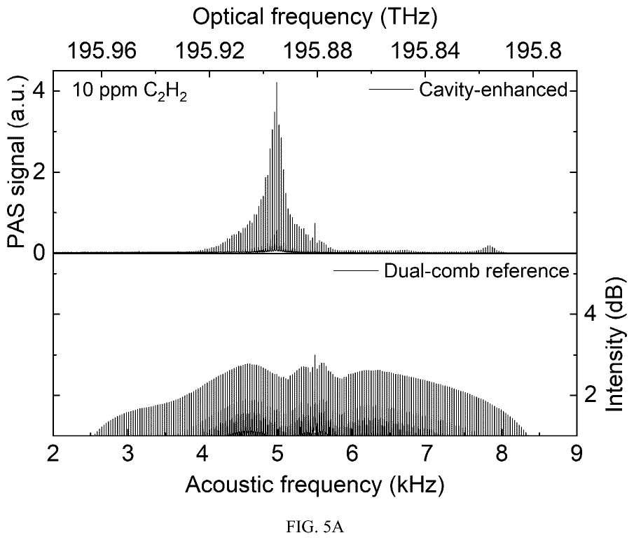

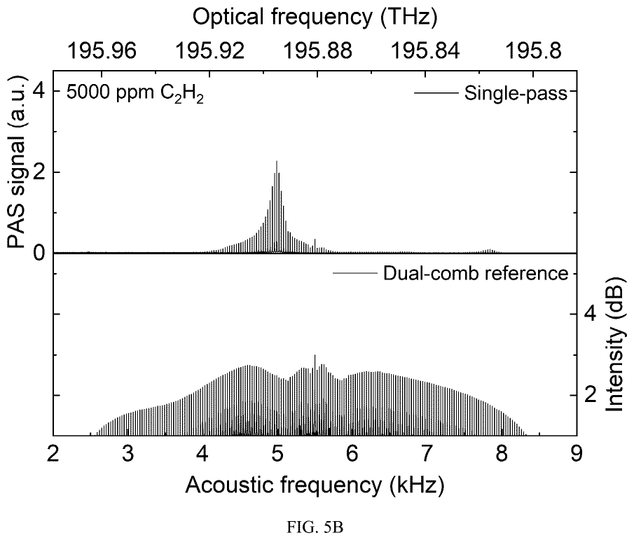

When C₂H₂ having a concentration of 10 ppm is introduced into the gas cell at an atmospheric pressure (760 Torr), the representative cavity-enhanced photoacoustic DCS signals are illustrated in the top panel of FIG. 5A. The strong spectral profile at 5 kHz in the acoustic frequency domain corresponds to the P(9) line of C₂H₂ at 195.895 THz in the optical domain. In contrast, the single-pass measurement is conducted by the same dual-comb source and acoustic resonator, but excluding the optical resonator from the experiment setup. As a result, a much higher concentration (5000 ppm) of C₂H₂ is required to achieve a similar signal level in FIG. 5B. The reference dual-comb spectrum recorded by the photodetector is plotted in the two bottom panels, showing the same profile in these two measurements. By taking into account the difference in the photoacoustic signal amplitude and gas concentration, the use of such a high-finesse cavity significantly enhances the dual-comb signal by a factor of 924. An average intracavity comb power of 130 mW is estimated for each pair of comb lines.

### Broadband Multi-Species Measurements

Over the telecommunications C-band (1527.3-1569.7 nm), cavity-enhanced photoacoustic DCS measurements of 10 ppm C₂H₂, 50 ppm NH₃ and 1% CO are conducted at the pressure of 760 Torr, respectively. The measurements are recorded with a data sampling rate of 500 kS/s and FFT resolution of 1 Hz. The photoacoustic spectrum is averaged over 60 seconds to improve the signal-to-noise ratio (SNR), followed by the amplitude normalization by the non-uniform comb-power envelope, the variation of cavity finesse over the wide spectral range, and the frequency response of the acoustic resonator. FIG. 6 shows the stitched photoacoustic spectra of C₂H₂, NH₃ and CO mixtures with a very high SNR. All the measurements are in good agreement with the simulated absorption spectra using the existing HITRAN database [35]. In particular, the inset graph demonstrates several very weak lines of C₂H₂ with absorption coefficients around 1×10⁻⁶ cm⁻¹. The polyatomic molecule NH₃ features a complex infrared spectrum with many blended lines, which are well resolved by the spectrometer as shown in the inset graph. It is noted that the overtone spectrum of CO in this wavelength range has a very small line-strength (mostly below 10⁻²³ cm⁻¹/(molecules cm⁻²)), which is 2-3 orders of magnitude smaller than these of C₂H₂ and NH₃.

### Linear Response and Detection Limit

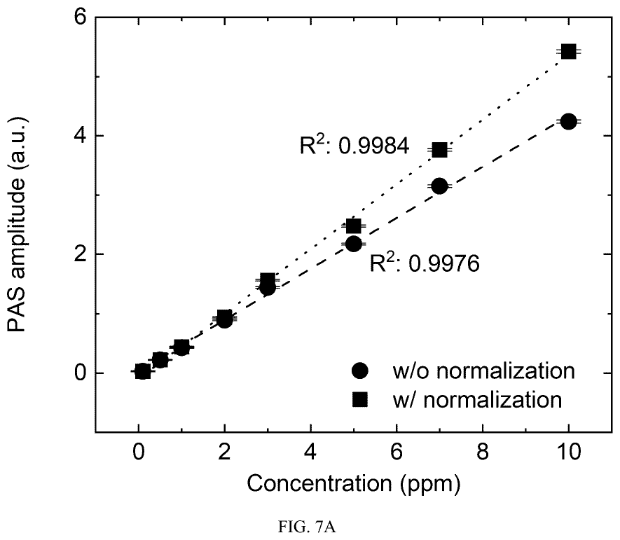

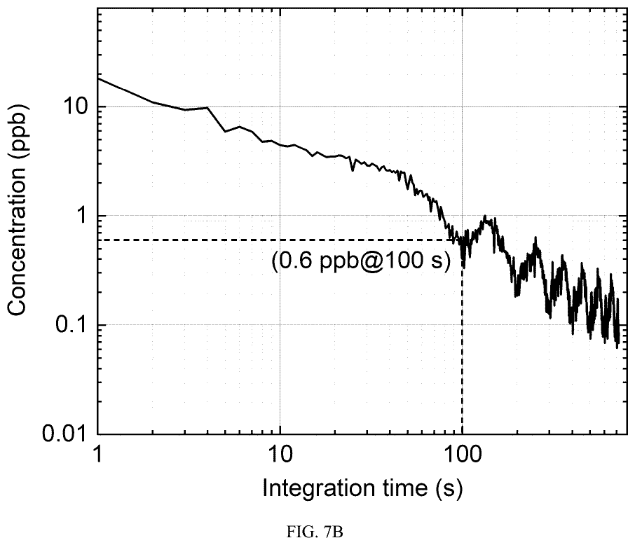

The strongest absorption line of each species is selected to evaluate the gas sensing performance. Herein the P(9) line of C₂H₂ at 195.895 THz with a line-strength of 1.211×10⁻²⁰ cm⁻¹/(molecules cm⁻²) is investigated. It is noted that the cavity finesse may degrade due to the strong absorption at a much higher gas concentration, thus affecting the linear response of cavity-enhanced gas sensors. With this factor taken into account, FIG. 7A plots the amplitude of the photoacoustic signal as a function of gas concentration for C₂H₂/N₂ mixtures, showing a good linear response (R²>0.99). The vertical error bar (1−σ standard deviation) is calculated from the variation of the peak amplitude acquired over a time period of 60 seconds. The Allan-Werle deviation analysis is then conducted to evaluate the long-term stability and detection limit by measuring zero gas (N₂) for one hour. The photoacoustic signal and the noise are evaluated at the same acoustic frequency, that is, 5290 Hz for C₂H₂ detection. As illustrated in FIG. 7B, the sensor demonstrates a minimum detection limit (MDL) of 0.6 ppb for C₂H₂ at the averaging time of 100 seconds, corresponding to the noise equivalent absorption (NEA) coefficient of 7×10⁻¹⁰ cm⁻¹. The blended lines (^{p}P(5,3)s, ^{p}P(5,3)a) of NH₃ at 195.731 THz with a line-strength of 1.35×10⁻²¹ cm⁻¹/(molecules cm⁻²) and the R(7) line of CO at 191.190 THz with a line-strength of 2.22×10⁻²³ cm⁻¹/(molecules cm⁻²) are also investigated with a good linearity.

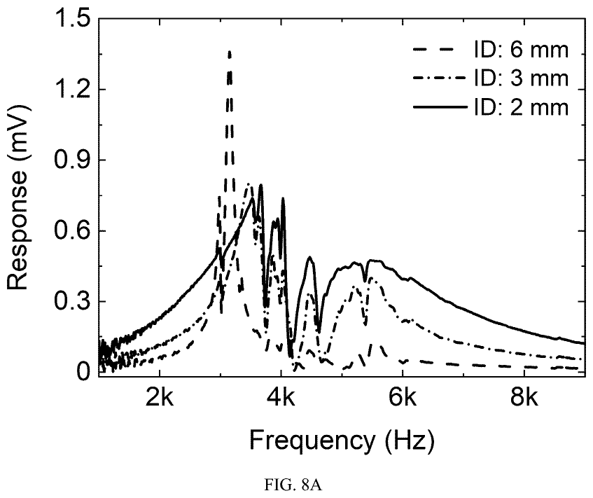

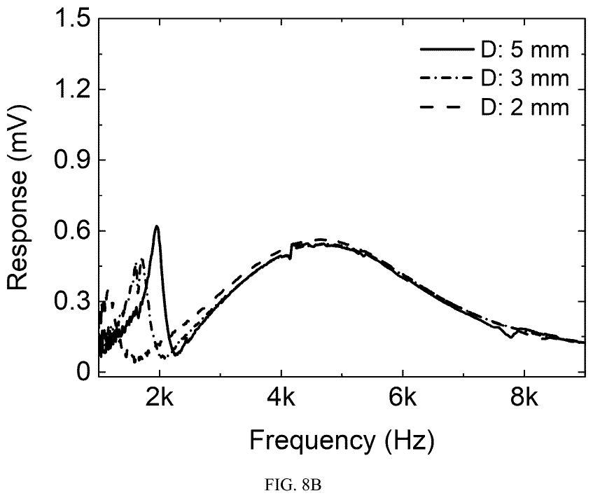

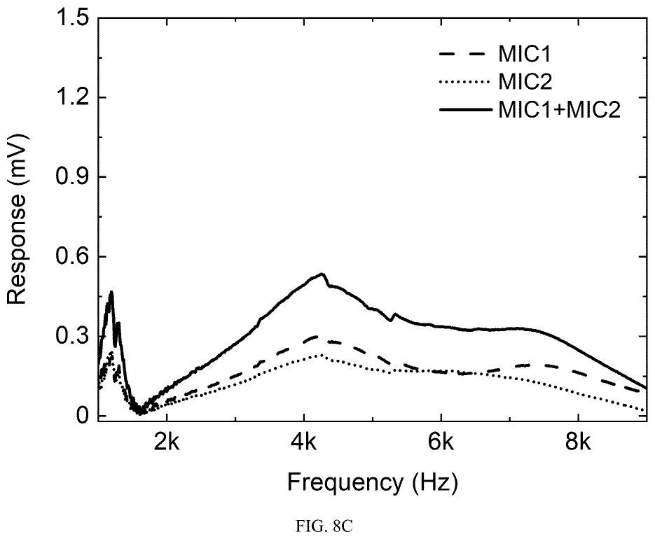

The flute-type acoustic resonator plays a significant role in cavity-enhanced photoacoustic DCS for broadband acoustic detection. Herein, the parameters affecting its frequency response are discussed. FIG. 8A illustrates different frequency responses of an open-ended longitudinal resonator with varied inner diameters. The resonator with an inner diameter of 2 mm excites more high-frequency acoustic modes. Two end caps are then added to cover the buffering volumes with a diameter of 12 mm; a central hole is made for optical access, leading to a smooth and broadband frequency response as shown in FIG. 8B. The configuration with a smaller hole (for example, 2 mm diameter) in the cap contributes to a broader frequency response (4108 Hz in bandwidth). Next, compared to the single microphone installed at the central position shown in FIGS. 8A and 8B, another hole is drilled nearby (6.5 mm away) for the installation of the second microphone. The generated electrical signals by the two microphones are summed by a low-noise circuit with the results plotted in FIG. 8C, showing a flat-top response with an increased bandwidth of 5088 Hz. The traditional photoacoustic resonator is characterized by a Q-factor of 38 and bandwidth of 150 Hz. Such a narrow bandwidth makes it unsuitable for amplifying multiple acoustic waves. In comparison, the resonator of the subject invention has a bandwidth of 5088 Hz, which is about 34 times larger. Besides, this bandwidth is about 1000 times broader than the normal quartz tuning fork used in photoacoustic spectroscopy. By targeting a broader flat-top frequency response with a larger signal amplitude, it is possible to further optimize the geometry of the acoustic resonator using finite element analysis. It is also interesting to explore acoustic resonators with bandwidths located at higher frequencies to reduce the 1/f noise.

The platform proves the feasibility of significantly enhancing the comb power by coupling both frequency combs into a high-finesse optical cavity. The successful implementation relies on the one-to-one matching between the comb line and the cavity mode, enabled by the precise control of the comb's two degrees of freedom (fᵣ and f_{c}) and the cavity length. The average optical power of each comb pair inside the cavity amounts to 130 mW, which can be further enhanced by the higher-finesse cavity. As simultaneous injection of dual combs into the cavity is needed for intracavity multi-heterodyne beating, the sharper resonance of the higher-finesse cavity may cause certain intensity attenuation for the comb line that is slightly off the cavity resonance. By applying an optical cavity with ten times larger finesse (40780) but reducing the cavity length from 18 cm to 6 cm, the FSR is tripled to 2.5 GHz and the cavity mode width is reduced to 61 kHz, only causing a slight attenuation of (<7%) of the comb intensity for the comb line index beyond 200.

With a coupling efficiency higher than 90%, the high-finesse cavity simultaneously enhances the optical power of hundreds of comb pairs by nearly three orders of magnitude. Benefiting from the broadband acoustic resonator and high-finesse optical cavity, the method of the subject invention enables the comb-line-resolved DCS measurement of trace amounts of C₂H₂, NH₃ and CO in the entire telecommunications C-band.

In contrast to the performance of the existing photoacoustic and photothermal DCS of C₂H₂ [23,25], the detection sensitivity is remarkably improved from ppm to sub-ppb level by the method of subject invention. Accordingly, the cavity-enhanced photoacoustic DCS can be employed as a highly powerful analytical tool for broadband, high-precision and high-sensitivity spectroscopic measurements and gas sensing applications.

Furthermore, the detection of trace gases may be notably optimized through the utilization of spectral measurements within the mid-infrared range. As mid-infrared dual-combs can be generated using the difference frequency generation of a near-infrared electro-optic comb, the method can be readily extended to the mid-infrared gas sensing applications. Although other types of mid-infrared frequency combs have been recently reported [6,7,19,40-44], one may devote to achieving the spectral overlap between the comb lines and cavity modes considering the different mechanisms for controlling the comb parameters. The comb-cavity locking method is suitable not only for electro-optic combs, but also for other fully stabilized comb sources.

### Materials and Methods

### Dual-Comb Source

The electro-optic comb is seeded by a CW external cavity diode laser emitting at optical frequency f_{c}. The seed laser is divided into two branches and each is connected in parallel to an AOM shifting the optical frequency by 25 MHz and 25.0055 MHz, respectively, leading to a center frequency of 5.5 kHz for the multiheterodyne beatnotes. The frequency comb is generated by intensity modulation using an electro-optic modulator (EOM), which is driven by 50-ps pulses at the repetition rates of 832.9525 MHz and 832.95253 MHz, respectively. As a result, a frequency spacing of 30 Hz is obtained for the multiheterodyne beats. After passing through EDFAs, the two frequency combs are counter-launched into a single dispersion compensated fiber with a length of 1 km, a high normal dispersion of −130 ps nm⁻¹ km⁻¹, and a low dispersion slope of −0.15 ps nm⁻² km⁻¹ for spectral broadening. Next, the two combs are mixed and split into two beams for photoacoustic detection and power normalization, respectively.

### Influence of Mismatch Between Comb Line and Cavity Mode

The finesse (F) of a Fabry-Pérot cavity comprising two identical high-reflectivity mirrors is determined by π\sqrt{R}/((1−R), where R is the reflectivity of the cavity mirrors. By measuring the reflectivity using the cavity-ring down method, the optical cavity used is determined to have a finesse of 4078. Considering the cavity length of 18 cm, the FSR is determined to be about 833 MHz (FSR=c/2L, where c is the speed of light and L is the cavity length). The cavity mode can be described by Equation (1) defining a Lorentzian line-shape:

$$y = \frac{1}{π} \times \frac{ω}{{( x - {x}_{c} )}^{2} + {ω}^{2}} \qquad ( 1 )$$

where ω and (x−x_{c}) are the full width at half maximum (FWHM) and the frequency shift relative to the line-center of the cavity mode, respectively. For the optical cavity, the FWHM of the cavity mode is 204 kHz at the wavelength near 1531 nm. Selecting a center frequency difference of 5.5 kHz via AOMs and a repetition frequency difference of 30 Hz, the largest frequency among the dual-comb multiheterodyne beats is 8.6 kHz. Provided that one train of frequency combs is in perfect resonance with the cavity modes, the maximum frequency mismatch between the counterpart of the dual-comb and the cavity mode is 8.6 kHz, corresponding to the intensity attenuation of only 0.66% according to Equation (1).

### Evaluation of Intracavity Dual-Comb Power

The comparison of the single-pass and the cavity-enhanced DCS signal in FIGS. 5A and 5B proves a power enhancement of 924 times. The incident power of the dual-comb source is 30 mW and the total number of comb line pair is about 213 mW. Hence, the average power is (30 mW×924)/213≈130 mW for each pair of comb lines. The optical cavity (finesse 4078 in vacuum) theoretically leads to an intracavity power enhancement by a factor of 1299. Considering the finesse degradation induced by 10 ppm C₂H₂, the cavity enhancement factor is reduced to 1016. Hence, the comparison of the theoretical enhancement factor and the experimental enhancement factor indicates a coupling efficiency of 91% for the dual-comb light.

### Signal-to-Noise Ratio Evaluation.

The strongest absorption line of the target species is selected for evaluating the SNR of the spectroscopic gas sensor. In the cavity-enhanced photoacoustic DCS, the corresponding radio frequencies for C₂H₂, NH₃, CO are located at 5290 Hz, 4480 Hz, and 6430 Hz, respectively. The noise is measured in the same manner by filling the gas cell with pure N₂.

Embodiment 1. A system for amplified broadband photoacoustic detection of multi-species with high-sensitivity, comprising:
a light source configured to generate a light beam having a wavelength covering absorption lines of target gaseous analytes;
a controller configured to control wavelength and intensity of the light beam;
an acoustic resonator configured to generate broadband frequency response configured to amplify generated acoustic waves over a wide frequency range;
an acoustic transducer configured to detect the generated acoustic waves;
an electrical sum circuit configured to add electrical signals from the acoustic transducer;
an optical resonator configured to enhance power of the light beam;
a gas cell configured to provide an absolute frequency standard;
a first locking loop configured to stabilize absolute wavelength of a light source by referencing to a molecular absorption line;
a second locking loop configured to stabilize longitudinal mode of the optical resonator by referencing to the stabilized light source;
a third locking loop configured to maintain stable power enhancement of the optical resonator;
a first photodetector configured to detect transmitted light from the gas cell to lock the light source to the absorption line of the gas filled in the gas cell;
a second photodetector configured to detect reflected light from the optical resonator to lock the light source to a longitudinal mode of the optical resonator;
an optical coupler configured to combine two light sources;
a lens configured to match a transverse mode of the light beam with a transverse mode of the optical resonator;
a combination of polarized beamsplitter (PBS) and quarter-wave plate (QWP) configured to separate the light reflected by a front mirror of the optical resonator from incident light;
an electrical splitter configured to split the electrical signal configured to generate different error signals;
three Pound-Drever-Hall (PDH) modules configured to extract the error signals and configured to generate feedback signals for the three locking loops; and
a piezoelectric (PZT) actuator attached to a rear mirror of the optical resonator to control a length between the two mirrors.

Embodiment 2. The system of embodiment 1, wherein the light source controlled by the controller is wavelength-modulated or intensity-modulated to generate acoustic waves after interacting with a gaseous analyte.

Embodiment 3. The system of embodiment 1, wherein the acoustic resonator configured to generate broadband frequency response comprises a longitudinal resonator sandwiched by a pair of buffers and a pair of caps with holes configured to obtain broadened frequency response.

Embodiment 4. The system of embodiment 3, wherein the acoustic resonator and the acoustic transducer each comprises microphones.

Embodiment 5. The system of embodiment 1, wherein the electrical sum circuit is configured to improve intensity of the acoustic signal and flatten the frequency response over a broad frequency range by summing electrical signals generated by the acoustic transducer.

Embodiment 6. The system of embodiment 1, wherein the light source is a single-wavelength light source or a light source with a broadband spectrum, comprising optical frequency combs.

Embodiment 7. The system of embodiment 1, wherein the power of the light source configured to generate acoustic waves is enhanced by an optical resonator.

Embodiment 8. The system of embodiment 7, wherein the optical resonator is a Fabry-Pérot optical cavity, bow-tie optical cavity, or another type of optical cavity for enhancing the optical power.

Embodiment 9. The system of embodiment 1, wherein the absolute wavelength of the light source is stabilized by referencing to a molecular absorption line via a frequency locking method based on PDH locking or another locking method including first harmonic locking.

Embodiment 10. The system of embodiment 1, wherein the longitudinal mode of the optical resonator is stabilized by referencing to the stabilized light source via PDH locking.

Embodiment 11. The system of embodiment 2, wherein the stable enhancement of the light power in the optical resonator for photoacoustic detection is achieved by maintaining resonance between the light source and the optical resonator by PDH locking.

Embodiment 12. The system of the embodiment 1, wherein the coupler is configured to allow two light sources to enter the optical resonator together to realize stable power enhancement of a dual-comb in the optical resonator.

Embodiment 13. The system of the embodiment 1, wherein the lens is configured to adjust the transverse mode of the light beam to match with the transverse mode supported by the optical resonator, maximizing coupling efficiency and achieving the maximum power in the optical resonator.

Embodiment 14. The system of the embodiment 1, wherein the combination of PBS and QWP is configured to retrieve the reflected light from the optical resonator as the reflected light is overlapped with the incident light.

Embodiment 15. The system of the embodiment 1, wherein the electrical splitter is configured to split the electrical signal from the photodetector for different locking loops.

Embodiment 16. The system of the embodiment 1, wherein the PDH modules integrate modulation and demodulation, in which modulation signals are sent to the controller or additional modulators to generate sidebands for implementing PDH locking.

Embodiment 17. The system of the embodiment 1, wherein the PZT actuator is attached to the rear mirror of the optical resonator to stabilize the longitudinal mode of the optical resonator following the feedback signal from the PDH module.

Embodiment 18. A method of cavity-enhanced photoacoustic dual-comb spectroscopy (DCS) for ultrasensitive, broadband, and high-resolution spectroscopic detection, comprising:
generating seed laser beams;
dividing the seed laser beams into two branches, each being connected in parallel to an acousto-optic modulator (AOM) shifting optical frequency by a different degree;
generating two trains of frequency combs by intensity modulating the two branches by electro-optic modulators (EOMs);
passing the two trains of frequency combs through Erbium-doped fiber amplifiers (EDFAs);
counter-launching the two trains of frequency combs into a single dispersion compensated fiber; and
mixing the two combs and splitting them into two beams for photoacoustic detection and power normalization, respectively.

Embodiment 19. The method of embodiment 18, wherein the two trains of frequency combs generated share a same carrier frequency.

Embodiment 20. The method of embodiment 18, wherein a first train of the frequency combs with a repetition rate f_{r,1}, locking the seed laser (f_{c}) to a Fabry-Pérot cavity enclosed in a gas cell, and enabling overlap between a central comb line and one cavity mode by a PDH method.

Embodiment 21. The method of embodiment 20, wherein a second train of the frequency combs is coupled to the cavity by tuning f_{r,1} such that it perfectly matches a free spectral range of the optical cavity.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] U.S. Pat. No. 7,263,871 B2.
[2] I. Sadiek, T. Mikkonen, M. Vainio, J. Toivonen, A. Foltynowicz, Optical frequency comb photoacoustic spectroscopy. Phys. Chem. Chem. Phys. 20 (2018) 27849-27855.
[3] X. Ren, M. Yan, Z. Wen, H. Ma, R. Li, K. Huang, H, Zeng, Dual-comb quartz-enhanced photoacoustic spectroscopy. Photoacoustics 28 (2022) 100403.
[4] EP Pat. No. 3865851 A1.
[5] M. Yan, P. Luo, K. Iwakuni, G. Millot, T. W. Hänsch, N. Picqué. Mid-infrared dual-comb spectroscopy with electro-optic modulators. Light Sci. Appl. 6 (2017) e17076.
[6] U.S. Pat. No. 7,538,881 B2.
1. Lee, S. J., Widiyatmoko, B., Kourogi, M. & Ohtsu, M. Ultrahigh scanning speed optical coherence tomography using optical frequency comb generators. Jpn J. Appl. Phys. 40, L878-L880 (2001).
2. Keilmann, F., Gohle, C. & Holzwarth, R. Time-domain mid-infrared frequency-comb spectrometer. Opt. Lett. 29, 1542-1544 (2004).
3. Schliesser, A., Brehm, M., Keilmann, F. & van der Weide, D. Frequency-comb infrared spectrometer for rapid, remote chemical sensing. Opt. Express 13, 9029-9038 (2005).
4. Yasui, T., Saneyoshi, E. & Araki T. Asynchronous optical sampling terahertz time-domain spectroscopy for ultrahigh spectral resolution and rapid data acquisition. Appl. Phys. Lett. 87, 061101 (2005).
5. Okubo, S. et al. Ultra-broadband dual-comb spectroscopy across 1.0-1.9 μm. Appl. Phys. Express 8, 082402 (2015).
6. Ycas, G. et al. High-coherence mid-infrared dual-comb spectroscopy spanning 2.6 to 5.2 μm. Nat. Photon. 12, 202-208 (2018).
7. Muraviev, A. V., Smolski, V. O., Loparo, Z. E. & Vodopyanov., K. L. Massively parallel sensing of trace molecules and their isotopologues with broadband subharmonic mid-infrared frequency combs. Nat. Photon. 12, 209-214 (2018).
8. Ideguchi, T. et al. Coherent Raman spectro-imaging with laser frequency combs. Nature 502, 355-358 (2013).
9. Dong, X. et al. Ultrafast time-stretch microscopy based on dual-comb asynchronous optical sampling. Opt. Lett. 43, 2118-2121 (2018).
10. Udem, T., Holzwarth, R. & Hánsch, T. Optical frequency metrology. Nature 416, 233-237 (2002).
11. Pupeza, I., Zhang, C., Högner, M. & Ye, J. Extreme-ultraviolet frequency combs for precision metrology and attosecond science. Nat. Photonics 15, 175-186 (2021).
12. Godbout, M., Deschênes, J. D., & Genest, J. Spectrally resolved laser ranging with frequency combs. Opt. Express 18, 15981-15989 (2010).
13. Boudreau, S., Levasseur, S., Perilla, C., Roy, S. & Genest, J. Chemical detection with hyperspectral lidar using dual frequency combs. Opt. Express 21, 7411-7418 (2013).
14. Rieker, G. B. et al. Frequency-comb-based remote sensing of greenhouse gases over kilometer air paths. Optica 1, 290-298 (2014).
15. Giorgetta, F. R. et al. Broadband phase spectroscopy over turbulent air paths. Phys. Rev. Lett. 115, 103901 (2015).
16. Vicentini, E., Wang, Z., Van Gasse, K., Hänsch, T. W. & Picqué., N. Dual-comb hyperspectral digital holography. Nat. Photon. 15, 890-894 (2021).
17. Martin-Mateos, P., Khan, F. U. & Bonilla-Manrique, O. E. Direct hyperspectral dual-comb imaging. Optica 7, 199-202 (2020).
18. Suh, M.-G., Yang, Q.-F., Yang, K. Y., Yi, X. & Vahala, K. J. Microresonator soliton dual-comb spectroscopy. Science 354, 600-603 (2016).
19. Villares, G., Hugi, A., Blaser, S., & Faist, J. Dual-comb spectroscopy based on quantum-cascade-laser frequency combs. Nat. Commun. 5, 5192 (2014).
20. Ideguchi, T. et al. Kerr-lens mode-locked bidirectional dual-comb ring laser for broadband dual-comb spectroscopy. Optica 3, 748-753 (2016).
21. Link, S. M., Maas, D. J. H. C., Waldburger, D. & Keller, U. Dual-comb spectroscopy of water vapor with a free-running semiconductor disk laser. Science 356, 1164-1168 (2017).
22. Coddington, I., Newbury, N. & Swann, W. Dual-comb spectroscopy. Optica 3, 414-426 (2016).
23. Wildi, T., Voumard, T., Brasch, V., Yilmaz, G. & Herr, T. Photo-acoustic dual frequency comb spectroscopy. Nat. Commun. 11, 4164 (2020).
24. Friedlein, J. T. et al. Dual-comb photoacoustic spectroscopy. Nat. Commun. 11, 3152 (2020).
25. Wang, Q., Wang, Z., Zhang, H. et al. Dual-comb photothermal spectroscopy. Nat Commun. 13, 2181 (2022).
26. Sadiek, I., Mikkonen, T., Vainio, M., Toivonen, J. & Foltynowicz, A. Optical frequency comb photoacoustic spectroscopy. Phys. Chem. Chem. Phys. 20, 27849-27855 (2018).
27. Ren, X. et al. Dual-comb quartz-enhanced photoacoustic spectroscopy. Photoacoustics 28, 100403 (2022).
28. Bernhardt, B. et al. Cavity-enhanced dual-comb spectroscopy. Nat. Photon. 4, 55-57 (2010).
29. Fleisher, A. J. et al. Coherent cavity-enhanced dual-comb spectroscopy. Opt. Express 24, 10424-10434 (2016).
30. Hoghooghi, N. et al. Broadband coherent cavity-enhanced dual-comb spectroscopy. Optica 6, 28-33 (2019).
31. Zhang, W., Chen, X., Wu, X., Li, Y. & Wei, H. Adaptive cavity-enhanced dual-comb spectroscopy. Photon. Res. 7, 883-889 (2019).
32. Millot, G. et al. Frequency-agile dual-comb spectroscopy. Nat. Photon. 10, 27-30 (2016).
33. Black, E. D. An introduction to Pound-Drever-Hall laser frequency stabilization. Am. J. Phys. 69, 79-87 (2000).
34. Yin, X., et al. Ppb-level H₂S detection for SF₆ decomposition based on a fiber-amplified telecommunication diode laser and a background-gas-induced high-Q photoacoustic cell. Appl. Phys. Lett. 111 031109 (2017).
35. Gordon, I. E. et al. The HITRAN2016 molecular spectroscopic database. J. Quant. Spectrosc. Radiat. Transf 203, 3-69 (2017).
36. Wang, Z., et al. Ultrasensitive photoacoustic detection in a high-finesse cavity with Pound-Drever-Hall locking. Opt. Lett. 44, 1924-1927 (2019).
37. Borri, S., et al. Intracavity quartz-enhanced photoacoustic sensor. Appl. Phys. Lett. 104, 091114 (2014).
38. El-Busaidy, S. A. S., Baumann, B., Wolff, M., Duggen, L. Modelling of open photoacoustic resonators. Photoacoustics, 18, 100161 (2020).
39. Yan, M. et al. Mid-infrared dual-comb spectroscopy with electro-optic modulators. Light Sci. Appl. 6, e17076(2017).
40. Adler, F. et al. Phase-stabilized, 1.5 W frequency comb at 2.8-4.8 μm. Opt. Lett. 34, 1330-1332 (2009).
41. Griffith, A. G. et al. Silicon-chip mid-infrared frequency comb generation. Nat. Commun. 6, 6299 (2015).
42. Jouy, P. et al. Dual comb operation of λ˜8.2 m quantum cascade laser frequency comb with 1 W optical power. Appl. Phys. Lett. 111, 141102 (2017).
43. Guo, H. et al. Mid-infrared frequency comb via coherent dispersive wave generation in silicon nitride nanophotonic waveguides. Nat. Photon. 12, 330-335 (2018).
44. Schwarz, B. et al. Monolithic frequency comb platform based on interband cascade lasers and detectors. Optica 6, 890-895 (2019).

We claim:

1. A system for amplified broadband photoacoustic detection of multi-species with high-sensitivity, comprising:
a light source configured to generate a light beam having a wavelength covering absorption lines of target gaseous analytes;
a controller configured to control wavelength and intensity of the light beam;
an acoustic resonator configured to generate broadband frequency response configured to amplify generated acoustic waves over a wide frequency range;
an acoustic transducer configured to detect the generated acoustic waves;
an electrical sum circuit configured to add electrical signals from the acoustic transducer;
an optical resonator configured to enhance power of the light beam;
a gas cell configured to provide an absolute frequency standard;
a first locking loop configured to stabilize absolute wavelength of a light source by referencing to a molecular absorption line;
a second locking loop configured to stabilize longitudinal mode of the optical resonator by referencing to the stabilized light source;
a third locking loop configured to maintain stable power enhancement of the optical resonator;
a first photodetector configured to detect transmitted light from the gas cell to lock the light source to the absorption line of the gas filled in the gas cell;
a second photodetector configured to detect reflected light from the optical resonator to lock the light source to a longitudinal mode of the optical resonator;
an optical coupler configured to combine two light sources;
a lens configured to match a transverse mode of the light beam with a transverse mode of the optical resonator;
a combination of polarized beamsplitter (PBS) and quarter-wave plate (QWP) configured to separate the light reflected by a front mirror of the optical resonator from incident light;
an electrical splitter configured to split the electrical signal configured to generate different error signals;
three Pound-Drever-Hall (PDH) modules configured to extract the error signals and configured to generate feedback signals for the three locking loops; and
a piezoelectric (PZT) actuator attached to a rear mirror of the optical resonator to control a length between the two mirrors.

2. The system of claim 1, wherein the light source controlled by the controller is wavelength-modulated or intensity-modulated to generate acoustic waves after interacting with a gaseous analyte.

3. The system of claim 1, wherein the acoustic resonator configured to generate broadband frequency response comprises a longitudinal resonator sandwiched by a pair of buffers and a pair of caps with holes configured to obtain broadened frequency response.

4. The system of claim 3, wherein the acoustic resonator and the acoustic transducer each comprises microphones.

5. The system of claim 1, wherein the electrical sum circuit is configured to improve intensity of the acoustic signal and flatten the frequency response over a broad frequency range by summing electrical signals generated by the acoustic transducer.

6. The system of claim 1, wherein the light source is a single-wavelength light source or a light source with a broadband spectrum, comprising optical frequency combs.

7. The system of claim 1, wherein the power of the light source configured to generate acoustic waves is enhanced by an optical resonator.

8. The system of claim 7, wherein the optical resonator is a Fabry-Pérot optical cavity, bow-tie optical cavity, or another type of optical cavity for enhancing the optical power.

9. The system of claim 1, wherein the absolute wavelength of the light source is stabilized by referencing to a molecular absorption line via a frequency locking method based on PDH locking or another locking method including first harmonic locking.

10. The system of claim 1, wherein the longitudinal mode of the optical resonator is stabilized by referencing to the stabilized light source via PDH locking.

11. The system of claim 2, wherein the stable enhancement of the light power in the optical resonator for photoacoustic detection is achieved by maintaining resonance between the light source and the optical resonator by PDH locking.

12. The system of claim 1, wherein the coupler is configured to allow two light sources to enter the optical resonator together to realize stable power enhancement of a dual-comb in the optical resonator.

13. The system of claim 1, wherein the lens is configured to adjust the transverse mode of the light beam to match with the transverse mode supported by the optical resonator, maximizing coupling efficiency and achieving the maximum power in the optical resonator.

14. The system of claim 1, wherein the combination of PBS and QWP is configured to retrieve the reflected light from the optical resonator as the reflected light is overlapped with the incident light.

15. The system of claim 1, wherein the electrical splitter is configured to split the electrical signal from the photodetector for different locking loops.

16. The system of claim 1, wherein the PDH modules integrate modulation and demodulation, in which modulation signals are sent to the controller or additional modulators to generate sidebands for implementing PDH locking.

17. The system of claim 1, wherein the PZT actuator is attached to the rear mirror of the optical resonator to stabilize the longitudinal mode of the optical resonator following the feedback signal from the PDH module.

18. A method of cavity-enhanced photoacoustic dual-comb spectroscopy (DCS) for ultrasensitive, broadband, and high-resolution spectroscopic detection, comprising:
generating seed laser beams;
dividing the seed laser beams into two branches, each being connected in parallel to an acousto-optic modulator (AOM) shifting optical frequency by a different degree;
generating two trains of frequency combs by intensity modulating the two branches by electro-optic modulators (EOMs);
passing the two trains of frequency combs through Erbium-doped fiber amplifiers (EDFAs);
counter-launching the two trains of frequency combs into a single dispersion compensated fiber; and
mixing the two combs and splitting them into two beams for photoacoustic detection and power normalization, respectively.

19. The method of claim 18, wherein the two trains of frequency combs generated share a same carrier frequency.

20. The method of claim 18, wherein a first train of the frequency combs with a repetition rate f_{r,1}, locking the seed laser (f_{c}) to a Fabry-Pérot cavity enclosed in a gas cell, and enabling overlap between a central comb line and one cavity mode by a PDH method.
